(19) United States
(12) Patent Application Publication
(10) Pub. No.: US 2024/0144295 A1
(43) Pub. Date: May 2, 2024

(54) GREENHOUSE GAS EMISSIONS MANAGEMENT METHOD

(71) Applicant: Asuene Inc., Tokyo (JP)

(72) Inventors: Kouhei NISHIWADA, Tokyo (JP); Takehiro WATASE, Tokyo (JP)

(21) Appl. No.: 18/469,293

(22) Filed: Sep. 18, 2023

(30) Foreign Application Priority Data
Nov. 1, 2022 (JP) 2022-175890

(51) Int. Cl. G06Q 30/018

(52) U.S. Cl. CPC G06Q 30/018

(57) ABSTRACT

The purpose of this invention is to provide a method for efficiently managing greenhouse gas emissions, including the calculation of greenhouse gas emissions by business operators. One embodiment of this invention is a method for managing greenhouse gas emissions, comprising: determining information on energy consumption based on information input by a business terminal; calculating the amount of greenhouse gas emissions based on the information on the amount of energy used; receiving, from the business terminal, input regarding activity data concerning which product is to be allocated a predetermined percentage of the activity related to the energy usage; and processing to assign a percentage of the energy usage to each product based on the activity data input.

### TECHNICAL FIELD

This invention relates to a method for managing greenhouse gas emissions.

### BACKGROUND ART

With regard to the greenhouse gas emissions of businesses associated with the use of fuel and electricity, etc., reporting systems for SCOPE 1 emissions (direct emissions by the company) and SCOPE 2 emissions (indirect emissions by the company) have become widespread, and progress has been made in the calculation and reduction efforts for SCOPE 1 and SCOPE 2 emissions.

Non-Patent Literature 1 recommends calculating SCOPE 3 emissions as emissions other than SCOPE 1 and SCOPE 2, i.e., emissions from the entire supply chain (raw material procurement, manufacturing, distribution, sales, disposal, etc.), including other related businesses, with the aim of further reducing greenhouse gas emissions by businesses.

### PRIOR ART LIST

### Non-Patent Literature

[Non-Patent Literature 1] “Concept of Calculating Supply Chain Emissions,” Ministry of the Environment, November 2017.

### SUMMARY OF THE INVENTION

### Technical Problem

However, although the technology disclosed in Non-Patent Literature 1 discloses the calculation method of greenhouse gas emissions related to SCOPE 3 or the like, it is very time-consuming for each business, especially companies and local governments, to collect and input a huge amount of data for emissions calculation, calculate the amount of emissions, and manage the calculation results. In particular, in the field of GHG emissions management, the introduction of advanced technology has been slow to improve operational efficiency because the number of SCOPEs whose emissions are subject to calculation is expanding, the data used as the basis for emissions calculation varies widely from one SCOPE to another, and the data management methods differ from one business to another.

Therefore, the purpose of this invention is to provide an efficient method of emissions management by reducing work man-hours in the area of GHG emissions management, such as the calculation of GHG emissions by businesses, through the use of advanced technology.

### Technical Solution

One embodiment of the invention is a method for managing greenhouse gas emissions, comprising: determining information on energy consumption based on input information from a business terminal; calculating the amount of greenhouse gas emissions based on the information on the amount of energy used; receiving business information input from the business terminal regarding the business location of a business operator; receiving location information from the business terminal; and determining the business location of the operator based on the location information and said business location information.

### Advantageous Effects

The invention provides an efficient method of management of calculation, etc. of greenhouse gas emissions by business operators.

### BRIEF DESCRIPTION OF THE DRAWINGS

FIG. 1 shows Greenhouse gas emissions management system according to the first embodiment of this invention.

FIG. 2 shows a functional block diagram of a management terminal comprising the greenhouse gas emissions management system.

FIG. 3 shows a functional block diagram of a business terminal comprising the greenhouse gas emissions management system.

FIG. 4 shows the details of the business data according to the first embodiment of this invention.

FIG. 5 shows a diagram explaining the details of invoice information according to the first embodiment of this invention.

FIG. 6 shows an example of transaction information according to the first embodiment of this invention.

FIG. 7 shows another example of transaction information according to the first embodiment of this invention.

FIG. 8 shows a flowchart diagram illustrating an example of the calculation process of greenhouse gas emissions according to the first embodiment of this invention.

FIG. 9 shows a flowchart diagram illustrating an example of a process for predicting the cause of a change in greenhouse gas emissions according to the first embodiment of this invention.

FIG. 10 shows a flowchart diagram illustrating an example of a transaction process of greenhouse gas emissions according to the first embodiment of this invention.

FIG. 11 shows a flowchart diagram of an example of the activity allocation process according to the first embodiment of this invention.

FIG. 12 shows an example of activity information according to the first embodiment of this invention.

FIG. 13 shows an example of allocating based on activity information according to the first embodiment of this invention.

FIG. 14 shows a flowchart diagram of an example of the process of obtaining activity information according to the first embodiment of this invention.

FIG. 15 shows a flowchart diagram of another example of the activity allocation process according to the first embodiment of this invention.

FIG. 16 shows another example of activity information according to the first embodiment of this invention.

FIG. 17 shows an example of a complete proportion based on activity information according to the first embodiment of this invention.

FIG. 18 shows an example of a non-full proportion based on activity information according to the first embodiment of this invention.

### DETAILED DESCRIPTION OF THE EMBODIMENTS

The following is a list and description of the contents of this embodiment of the invention. The greenhouse gas emissions management system (hereinafter simply referred to as “the system”) according to this embodiment of the invention comprises the following:

[Item 1]

A method for managing greenhouse gas emissions, comprising:
determining information on energy consumption based on information input by a business terminal;
calculating the amount of greenhouse gas emissions based on the information on the amount of energy used;
receiving, from the business terminal, input regarding activity data concerning which product is to be allocated a predetermined percentage of the activity related to the energy usage; and processing to assign a percentage of the energy usage to each product based on the activity data input.

[Item 2]

The method of managing according to item 1, wherein the energy usage includes electricity usage.

[Item 3]

The management method according to item 1, wherein the expiration date of the activity data is checked, and if the expiration date has expired, the input regarding the activity data is disabled.

[Item 4]

The management method according to item 1, wherein if there is no activity related to any of the products, the expiration date of the activity data is checked, and the process is performed to assign a percentage of energy usage to each product based on the expired activity data.

[Item 5]

The management method according to item 1, wherein if there is no activity for any of the products, the process is performed to assign a percentage of energy usage for each product based on the input of the activity data.

### Embodiment 1

The following is a description of the system according to this embodiment, with reference to the drawings.

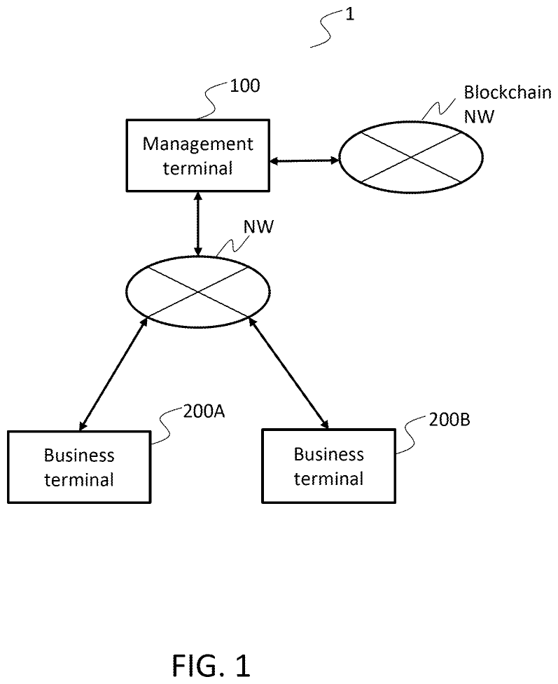

FIG. 1 illustrates a greenhouse gas emissions management system according to the first embodiment of this invention.

As shown in FIG. 1, in this embodiment of the emissions management system 1, a management terminal 100 and multiple business terminals 200A and 200B are connected to each other via a communication network NW.

For example, the management terminal 100 receives from the business terminals 200A and 200B basic information about the business and input information for calculating greenhouse gas (e.g., CO2) emissions (e.g., image data of billing information).

The management terminal 100 analyzes the received image data of the invoice information by machine learning, extracts the necessary items of the invoice information contained in the image data, and calculates the amount of greenhouse gas emissions. The management terminal 100 also analyzes the calculated changes (e.g., increase/decrease) in the amount of greenhouse gas emissions over time using machine learning to predict the cause of the change.

Furthermore, the management terminal 100 has a wallet and connects to a public blockchain network NW. The management terminal 100 generates a single hash value using SHA256 or other hash function based on the above information on greenhouse gas emissions for each predetermined period and records it in the blockchain network as transaction information. On the blockchain network, this block is generated based on the transaction information, the hash value recorded in the preceding block, and the nance value mined by the node, and is recorded following the preceding block to form a blockchain. Here, the above-mentioned hash generation and/or recording of transaction information into the blockchain can be performed via other terminals instead of the management terminal 100. In this case, the management terminal 100 transmits the amount of greenhouse gas emissions calculated in the matching process to the other terminals. Furthermore, the management terminal 100 can record the information about greenhouse gas emissions as a smart contract in the blockchain network. By using smart contracts, contracts for emissions trading with other businesses can be automatically generated, approved, and executed without the need for a third party, based on the above information about emissions. In addition, the smart contract enables each business operator to refer to the transaction information without having to go through the management terminal, increasing service convenience and reducing operational costs.

Here, as mentioned above, public blockchains can ensure higher data tamper-resistance and fault-tolerance compared to private blockchains because transactions are approved by an unspecified number of nodes and miners, not by a specific administrator, thus ensuring the security of the transactions. Therefore, it is preferable to use a public blockchain as the destination for recording electricity transactions in this embodiment. Representative public blockchains include Bitcoin, Ethereum, etc. For example, Ethereum has higher non-tampering and reliability among public blockchains.

The management terminal 100 can also associate information on greenhouse gas emissions by identifier or other means and record it in the blockchain network as a Non-Fungible Token (“NFT”). NFTs are, for example, tokens issued under the “ERC721” standard of Etherium, a blockchain network platform, and are units of data that are recorded in the blockchain network and have a non-fungible character. NFTs are recorded on the blockchain together with smart contracts and are traceable, thus providing proof of transaction information, including details and history, such as business information that controls greenhouse gas emissions.

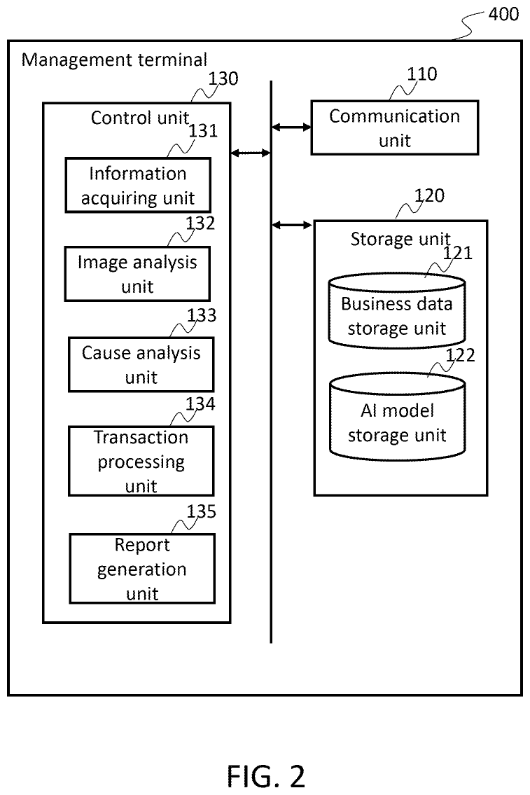

FIG. 2 is a functional block diagram of the management terminal comprising the emissions management system.

Communication unit 110 is a communication interface for communicating with external terminals via the network NW, for example, using communication protocols such as TCP/IP (Transmission Control Protocol/Internet Protocol).

The storage unit 120 stores programs and input data for executing various control processes and functions in the control unit 130, and comprises RAM (Random Access Memory), ROM (Read Only Memory), and the like. The storage unit 120 also has a business data storage unit 121 that stores various data related to businesses, and an AI model storage unit 122 that stores training data and training models learned by AI (artificial intelligence) from the training data. A database (not shown) storing various data may be constructed outside the storage unit 120 or the management terminal 100.

The control unit 130 controls the overall operation of the management terminal 100 by executing a program stored in the storage unit 120, and comprises a CPU (Central Processing Unit), GPU (Graphics Processing Unit), or the like. The functions of the control unit 130 include: an information reception unit 131 that accepts information from external terminals such as the business terminal 200; an image analysis unit 132 that analyzes image data received from the business terminal, such as billing information, and calculates greenhouse gas emissions; a cause analysis unit 133, which analyzes the image data and analyzes the cause of chronological changes in GHG emissions calculated based on the information contained in the extracted invoice information; a transaction processing unit 134, which summarizes the information on greenhouse gas emissions for a predetermined period of time, generates a hash value, and records the hash value as transaction information in the blockchain network; and a report generation unit 135 that generates and transmits report data for outputting the results of the analysis of the cause of the greenhouse gas emissions and changes in emissions to the operator for each predetermined period of time.

Although not shown in the figure, the control unit 130 has an image generation unit to generate screen information to be displayed via the user interface of an external terminal such as the business terminal 200. For example, using image and text data stored in storage unit 120 as materials, the information displayed on the user interface is generated by arranging various images and text in predetermined areas of the user interface based on predetermined layout rules. The processing related to the image generation unit can also be performed by a GPU (Graphics Processing Unit).

The management terminal 100 also has a wallet (not shown) necessary to record transaction information to the blockchain network. This wallet may be external to the management terminal 100.

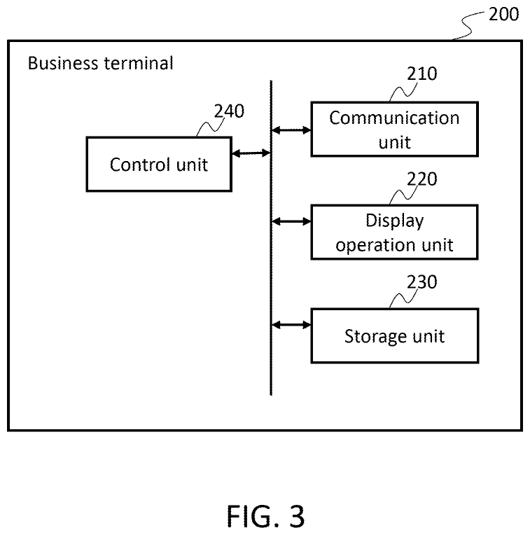

FIG. 3 is a functional block diagram of the business terminal comprising the emissions management system.

The business terminal 200 has a communication unit 210, a display operation unit 220, a storage unit 230, and a control unit 240.

The communication unit 210 is a communication interface for communication with the management terminal 100 via the network NW, for example, using communication protocols such as TCP/IP.

The display operation unit 220 is a user interface used by the business terminal 200 to input instructions and display text, images, etc. in response to input data from the control unit 240, and comprises a display and keyboard or mouse when the business terminal 200 is comprised of a personal computer, and when business terminal 200 is comprised of a smartphone or tablet terminal, it comprises a touch panel, etc. The display operation unit 220 is activated by a control program stored in the storage unit 230 and executed by the business terminal 200, which is a computer (electronic computer).

The storage unit 230 stores programs, input data, and other data for executing various control processes and each function within the control unit 240, and comprises RAM, ROM, and other components. The storage unit 230 also temporarily stores the contents of communication with the management terminal 100.

The control unit 240 controls the overall operation of the business terminal 200 by executing a program stored in the storage unit 230, and comprises a CPU, GPU, or the like.

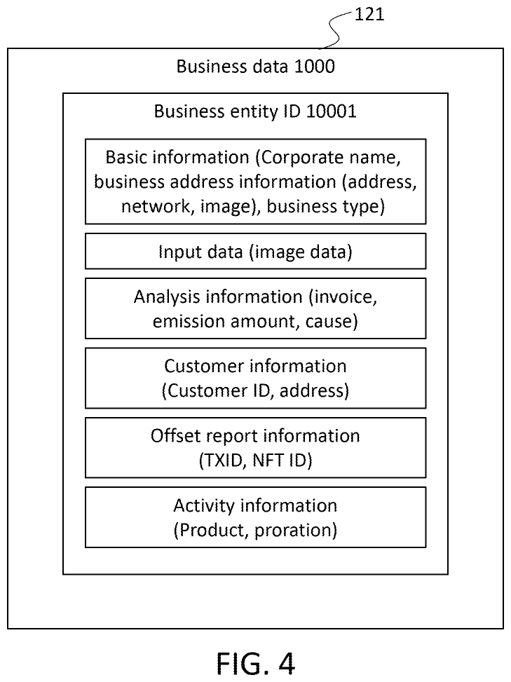

FIG. 4 illustrates the details of the business data according to the first embodiment of this invention.

The business data 1000 shown in FIG. 4 stores various data related to a business operator, obtained from the business operator via the business terminal 200. In FIG. 4, for convenience of explanation, an example of one business entity (the business entity identified by the business entity ID “10001”) is shown, but information on multiple business entities can be stored. Various data related to the business entity include, for example, basic information of the business entity (e.g., the business entity's corporate name, user name, business location information (e.g., address information for each business location, etc.), network name (e.g., SSID, IP address, etc.), and image information (e.g., background image of the business location, human image, etc.), business type, contact information, e-mail address, business office name, affiliated company name, and names of related businesses in the supply chain), input information (e.g., image data of invoice information), and analysis information (e.g, information related to invoices extracted from image data, GHG emissions, predicted causes of changes in GHG emissions, etc.), customer information (e.g., customer ID, blockchain address, etc.), and offset report information (e.g., TXID, NFTID, etc.), activity information (information on which products are allocated a given percentage of activities related to energy use).

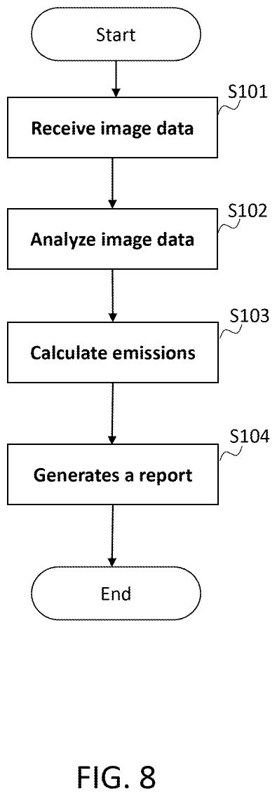

FIG. 8 is a flowchart diagram showing an example of the calculation process of greenhouse gas emissions according to the first embodiment of this invention.

First, as part of the process in step S101, the information acquisition unit 131 of the control unit 130 of the management terminal 100 acquires from the business terminal 200, via the network NW, image data collected by the business, including invoice information. The business uploads invoices, receipts, vouchers, etc. (collectively referred to as “invoices” in this embodiment) in PDF, Excel, JPG, or other file formats (collectively referred to as “image data” in this embodiment) to the management terminal 100 via the business terminal 200. The image data acquired by the information acquisition unit 131 is stored as input information in the business data storage unit 121 of the storage unit 120.

Then, as the process of step S102, the image analysis unit 132 of the control unit 130 of the management terminal 100 analyzes the image data acquired in the previous step using machine learning. The image analysis unit 132 of the control unit 130 of the management terminal 100 uses the so-called OCR method to analyze the image data, and the image analysis unit 132 of the management terminal 100 uses the learning model generated by learning the image data of multiple invoices of various styles stored in the AI model storage unit 122 of the storage unit 120 in advance. Text is recognized from the image data and items included in the invoice information are extracted as structured character string data. For image analysis, an image analysis engine (such as an OCR engine) provided by a business terminal other than the management terminal 100, which may be linked through an API, can be used.

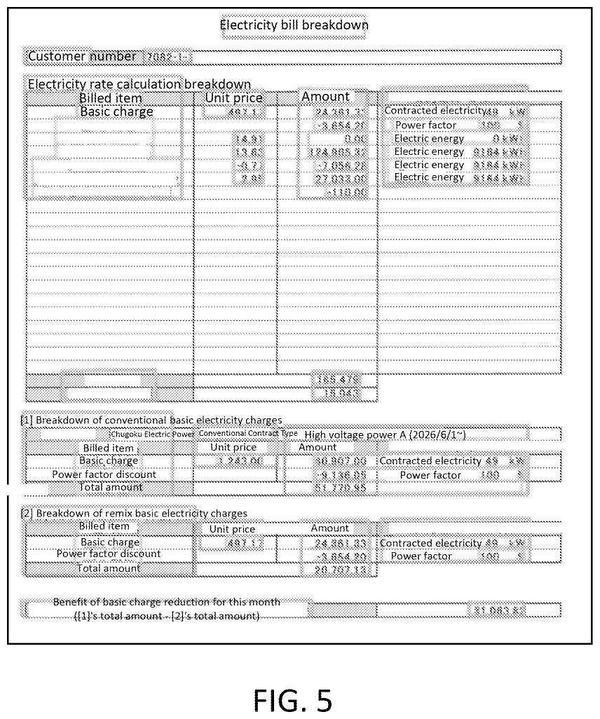

Image analysis is performed, for example, by recognizing and extracting text from image data containing bill information, as shown in FIG. 5.

As shown in FIG. 5, the bill information includes various items included in the bill, such as the name of the electricity bill breakdown, the amount of money for each breakdown (yen), the contracted power (kW), the amount of electricity used for each breakdown (kWh), the total amount of money (yen), and the date (year and month). In this example, the electricity bill breakdown is shown as an example, but it can be a bill for other energy usage including gas and fuel, in addition to electricity, and it can also be, for example, a receipt for travel expenses, a receipt for employer's commuting expenses, a bill for transactions with freight carriers, a bill for transactions with waste disposal operators, etc. The image analysis unit 132 can extract textual information, such as the amount information and the following activity quantity information, from the image data of these invoice information by analyzing the images. The extracted invoice information is stored as analysis information in the business data storage unit 121 of the storage unit 120. Thus, by using machine learning to analyze images, businesses can obtain a vast amount of necessary information for calculating greenhouse gas emissions as image data without having to manually input invoice information, etc., and can accurately extract the information necessary for calculating greenhouse gas emissions through highly accurate image recognition, thereby realizing more efficient and accurate calculation of greenhouse gas emissions.

Next, in step S103, the image analysis unit 132 of the control unit 130 calculates greenhouse gas emissions based on the billing information extracted from the image data. SCOPE1 is the direct emissions of GHGs by the business itself (e.g., emissions from fuel combustion and industrial processes), SCOPE2 is the indirect emissions from the use of electricity, heat, gas, etc. supplied to the business by other companies, and further, SCOPE 3 is a GHG Protocol-issued standard for calculating the emissions of an organization's entire supply chain (the entire flow of raw material procurement, manufacturing, distribution, sales, disposal, etc.). SCOPE 3 further includes 15 categories: 1) purchased products/services, 2) capital goods, 3) fuel and energy-related activities not included in SCOPE 1 and 2, 4) transportation and delivery (upstream), 5) waste from operations, 6) business travel, 7) employee commuting, 8) leased assets (upstream), 9) transportation and delivery (downstream), 10) processing of products sold, 11) use of products sold, 12) disposal of products sold, 13) leased assets (downstream), 14) franchises, and 15) investments. Greenhouse gases include carbon dioxide (CO2), methane (CH4), dinitrogen monoxide (N2O), hydrofluorocarbons (HFCs), perfluorocarbons (PFCs), sulfur hexafluoride (SF6), and nitrogen trifluoride (NF3). CO2 is used as an example in this embodiment.

Furthermore, greenhouse gas emissions are calculated based on the activity quantities defined as the amount of electricity used by a business, the amount of freight transported, the amount of waste disposal, and the amount of various transactions. The activity amounts are then multiplied by CO2 emissions per 1 kWh of electricity used, CO2 emissions per 1 ton of freight transported, and CO2 emissions per 1 ton of waste incinerated as emission intensity. Greenhouse gas emissions are calculated for each of SCOPE 1, SCOPE 2, and SCOPE 3 (15 categories for SCOPE 3), and the total emissions are calculated as supply chain emissions.

In this embodiment, the image analysis unit 132 extracts relevant billing information by SCOPE1, SCOPE2, and SCOPE3 (and further by category for SCOPE3), and calculates emissions based on the above calculation unit based on, for example, kWh of electricity consumption in the billing information. The calculated emissions are stored as analysis information in the business data storage unit 121 of the storage unit 120.

Then, as the process of step S104, the report generation unit 135 of control unit 130 generates a visualized report showing the breakdown of emissions by SCOPE (and further by category for SCOPE 3) in time series, based on the above calculated information on the amount of emissions.

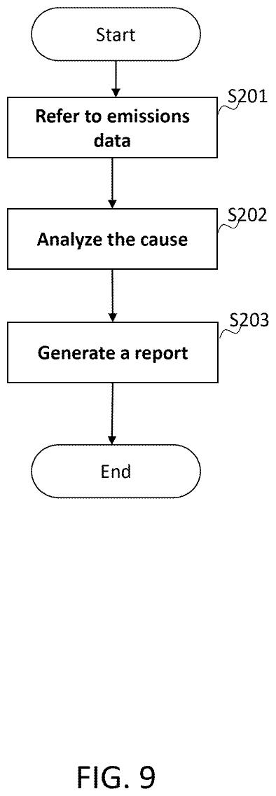

FIG. 9 is a flowchart diagram showing an example of a process for predicting the causes of changes in greenhouse gas emissions according to the first embodiment of this invention.

First, as the process of step S201, the cause analysis unit 133 of the control unit 130 of the management terminal 100 refers to the information on the business terminal's greenhouse gas emissions calculated in step S103 of FIG. 8. Here, the greenhouse gas emissions are referenced by SCOPE (and further by category for SCOPE 3). In addition, the cause analysis unit 133 can check for changes (increase or decrease) in emissions by referring to past emissions data for the same business with respect to the amount of greenhouse gas emissions. As described above, emissions are stored as assessment unit information in the business data storage unit 121 of the storage unit 120.

Then, as the process of step S202, the cause analysis unit 133 analyzes and predicts the cause of the change in emissions by machine learning based on the above referenced information on emissions. In analyzing the cause, the cause analysis unit 133 of the control unit 130 of the management terminal 100 uses the above referenced information on emissions, factors affecting the change (increase/decrease) in emissions, and a learning model generated by learning data on factors affecting emission changes (increase or decrease), stored in the AI model storage unit 122 in the storage unit 120, in advance, to predict the causes of changes in emissions by SCOPE (and further by category for SCOPE 3).

Factors that influence changes in emissions (increase or decrease) include, for example, weather, temperature, product demand and/or factory operations, store or factory opening or operating hours, equipment or facility changes, strategies implemented by software, energy-saving practices, fuel conversion, energy menu changes, variations in business travel or commuting distances and the amount of on-site power generation. Each of these factors can affect the emissions of any of the SCOPEs. For example, the weather factor could affect precipitation, wind speed, sunshine duration, and temperature. Precipitation affects small hydropower generation, wind speed affects wind power generation, sunshine duration affects solar power generation, and temperature affects air conditioning systems. Moreover, power generation has an influence on self-generation amounts, which in turn, affect CO2 emissions from electricity usage. This, in effect, affects the variations in Scope 2 emissions. On the other hand, air conditioning systems can impact gas consumption, which, in turn, affects CO2 emissions from gas combustion. Consequently, this has an effect on the variations in Scope 1 emissions. In addition, power-saving activities, plant operation due to product demand, and operating hours affect electricity consumption, which in turn affects SCOPE 2. In addition, EMS, replacement of refrigeration equipment, installation of energy-saving equipment, and automobile usage also affect electricity usage, which in turn affects SCOPE2, while automobile usage, fuel consumption, boiler usage, and boiler efficiency affect fuel usage, which in turn affects CO2 emissions from fuel, which in turn affects SCOPE1.

Additionally, the following factors impact the corresponding Scope 3 categories: product sales volume affects categories 1, 9, 10, 11, and 12; facility investments influence category 2; renewable energy ratio and energy procurement amounts impact category 3; transportation frequency and changes in transportation routes affect categories 4 and 9; product loss rate influences category 5; business trips and in-office employee numbers impact category 6; commuter numbers and in-office staff numbers affect category 7; power consumption influences category 8; processing reduction due to product improvements impacts category 10; improvements leading to energy-saving products influence category 11; increased recycling rate affects category 12; office electricity consumption in rented spaces corresponds to category 13; franchise emissions are linked to category 14; emissions from investments in various entities impact category 15.

Thus, by learning which factors affect which SCOPE or category by machine learning, and by obtaining information on emissions and each factor from the business, it is possible to predict the cause of changes in emissions. By using machine learning to predict the causes of emissions, it is possible to efficiently and accurately predict the factors that affect changes in GHG emissions for each business and for each SCOPE.

Then, as the process of step S203, the report generation unit 135 of the control unit 130 generates a visualized report on the causes of changes in emissions by SCOPE (and further by category for SCOPE 3), based on the above analyzed information on the predicted causes of changes in emissions.

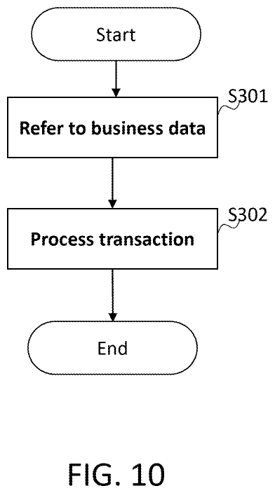

FIG. 10 is a flowchart diagram of an example of a greenhouse gas emissions transaction process according to the first embodiment of this invention.

First, in step S301, the transaction processing unit 134 of the control unit 130 of the management terminal 100 refers to the business data stored in the business data storage unit 121 of the storage unit 120. Here, the business operator data to be referenced includes analysis information (greenhouse gas emissions per SCOPE) and other data of the business operator.

Next, as the process in step S302, the transaction processing unit 134 generates a hash value based on the business data referenced in step S301. In other words, the transaction processing unit 134 generates one line of hash value for greenhouse gas emissions for a given period using a hash function and records the hash value as transaction information in the public blockchain. On the blockchain network, a new block is generated based on the transaction information, the hash value recorded in the preceding block, and the Nance value mined by the node. This new block is then recorded following the preceding block, forming a blockchain. Here, in this example, the block may be recorded in layer 2 (e.g., sidechain), which is different from the main blockchain (so-called layer 1), in order to reduce the costs associated with blockchain recording.

The transaction processing unit 134 can also assign and manage NFTIDs in connection with blockchain records of greenhouse gas emissions of the business. More specifically, as shown in FIG. 4, the business data 1000 can be assigned the customer ID of the business and store the blockchain address to be referenced as customer information, and the NFTID and TXID can be assigned as offset report information.

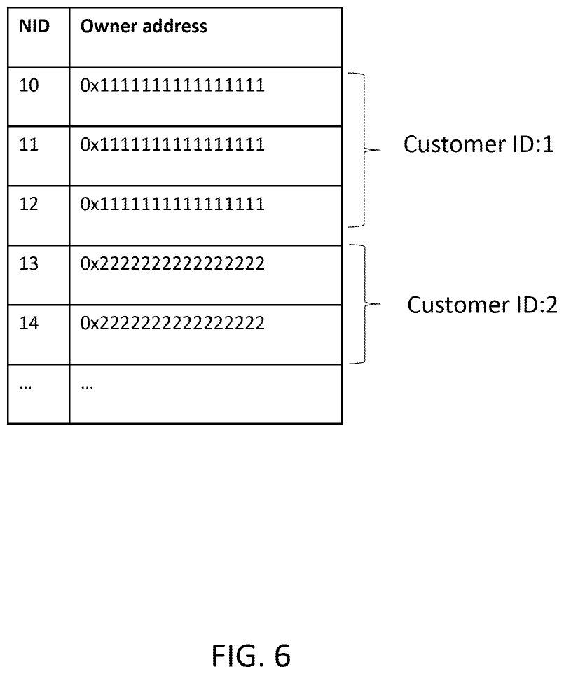

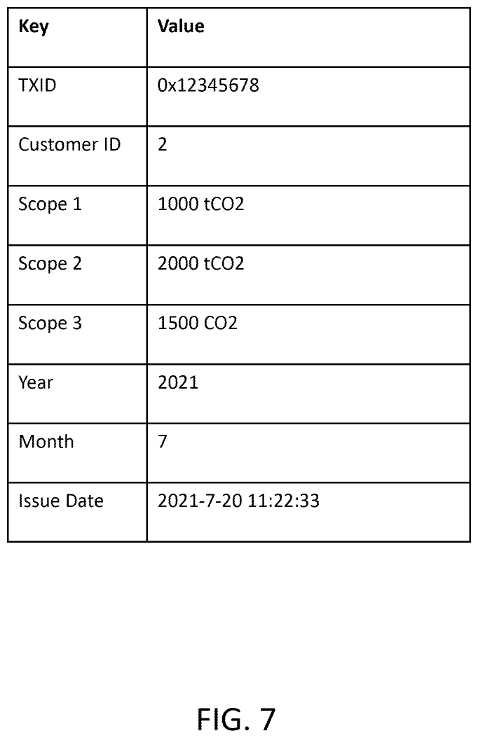

As shown in FIG. 6, blockchain addresses are associated with each NFTID on the blockchain network, and the NFTID and customer ID are managed at the management terminal 100. For example, information on greenhouse gas emissions for the business corresponding to customer ID “2” can be read by referring to the blockchain address for each NFTID, such as NFTID “13” and “14,” and the details of the emissions information can be read as shown in FIG. 7. FIG. 7 shows the information about the offset report corresponding to NFTID “14”, where the TXID is assigned to the offset report and the CO2 emissions by SCOPE, the subject year and month, and the date the report was issued are included in the offset report. In addition to the CO2 emissions for the target year and month in this example, the CO2 emissions for the most recent year, the CO2 emissions reduced, and the CO2 emissions offset can also be NFTed. By managing CO2 emissions through NFTs in this way, businesses can trade NFTed certificates while ensuring non-tampering and transaction reliability, and can also provide proof of emissions to third parties.

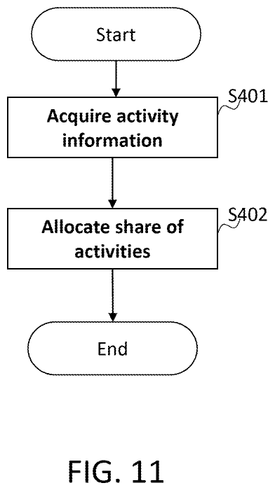

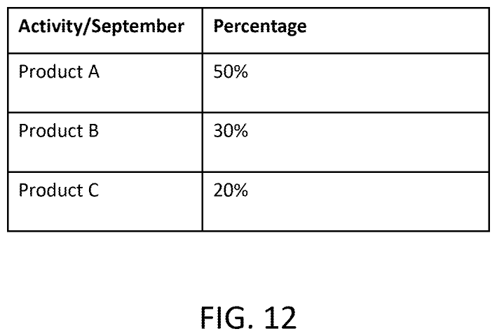

FIG. 11 shows a flowchart diagram of an example of the activity allocation process according to the first embodiment of this invention. For activities related to energy consumption acquired when calculating greenhouse gas emissions, the business sets in advance which product is to be allocated a predetermined percentage of energy consumption (in this example, electricity) as activity information, and records it as business data 1000 in the business data storage unit 121. As shown in FIG. 12, for example, the business operator sets the percentage of electricity to be allocated to Product A, Product B, and Product C, which are manufactured by the business, 50%, 30%, and 20%, respectively, for the activity with an expiration date in September.

Then, as the process of step S401, the report generation unit 135 of the control unit 130 of the management terminal 100 refers to the business data 1000 stored in the business data storage unit 121 to acquire activity information.

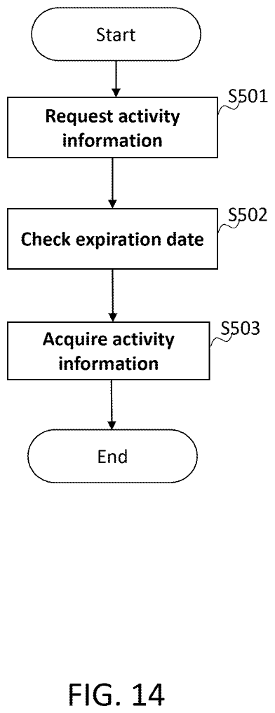

As shown in FIG. 14, in the process of acquiring activity information, the information acquisition unit 131 of the control unit 130 of the management terminal 100 receives a request for activity information from the business terminal 200 via the network NW as the process of step S501. In requesting activity information, the business operator enters information regarding the expiration date of the activity (e.g., “September 2022”).

As a subsequent process in step S502, the report generator 135 compares the expiration date of the activity entered by the business with the current date information to see if the expiration date of the activity has not expired. Here, when the business operator inputs the expiration date of the activity information, the input of activity information that has already expired (e.g., activity information with an expiration date of “August 2022”) can be disabled. For example, on the screen for selecting the expiration date of activity information displayed on the business terminal 200, if a business requests activity information in September 2022, it is possible to disable the display of activities with an expiration date of “August 2022,” and as a result, only activity information with an expiration date of “September 2022” or later, which has not expired, can be selected.

Then, as the process of step S503, if the expiration date of the activity information entered by the business (e.g., activity information with “September 2022” as the expiration date) has not expired, the report generator 135 refers to the business data 1000 stored in the business data storage unit 121 to acquire the requested activity information (e.g., activity information with an expiration date of “September 2022”).

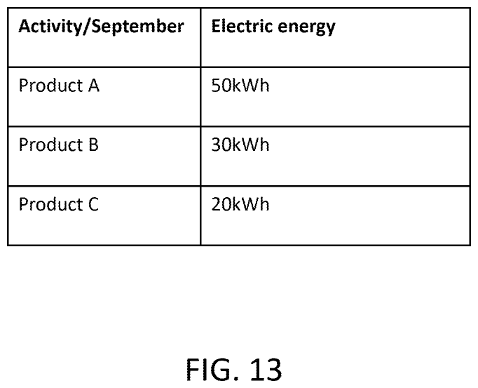

Returning to FIG. 11, as the process of step S402, the report generator 135 refers to the business data 1000 and performs the activity allocation process based on the stored information on the amount of electricity and the requested activity information. For example, if the amount of electricity used in September is 10000 kWh, the report generator 135 performs a process to allocate the amount of electricity by a predetermined percentage for each product, as shown in FIG. 13, based on the activity information with an expiration date in September. For example, for Product A, 50% of 10000 kWh is allocated, for Product B, 30% of 100 kWh is allocated, and for Product C, 20% of 100 kWh is allocated, calculated as 50 kWh, 30 kWh, and 20 kWh, respectively, and processed to generate the information as activity results information.

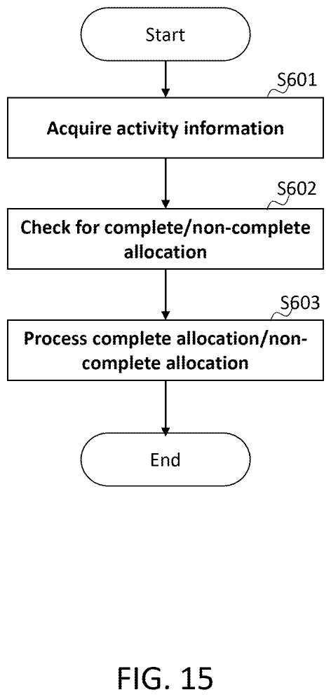

FIG. 15 shows a flowchart diagram of another example of the activity allocation process according to the first embodiment of this invention.

First, as described in FIG. 11, in step S601, the report generation unit 135 of the control unit 130 of the management terminal 100 refers to the business data 1000 stored in the business data storage unit 121 to acquire activity information.

Here, if the business did not manufacture “Product C” in the current month for the activity information with an expiration date of “September 2022,” which allocates the amount of electricity against the activity concerning Product A, Product B and Product C, if there was no activity for any of the products for the acquired activity information, as the process of step S602, the information acquisition unit 131 of the control unit 130 of the management terminal 100 receives a request from the business terminal 200, via the network NW, whether to perform a “complete allocation” or a “non-proportion” process. The “complete allocation” means that the total amount of electricity allocated to each product that the business operator is active (e.g., manufacturing) should be 100% of the amount of electricity used during the month, and “non-perfect allocation” means that the total amount of electricity allocated to each product that the business operates (e.g., manufactures) is not 100% of the amount of electricity used during the month.

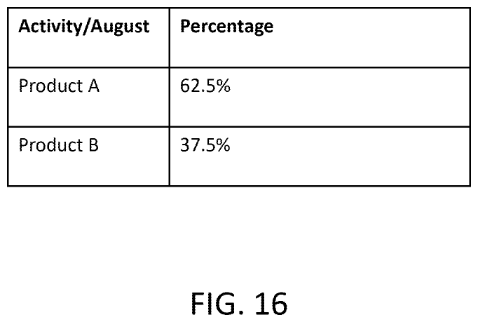

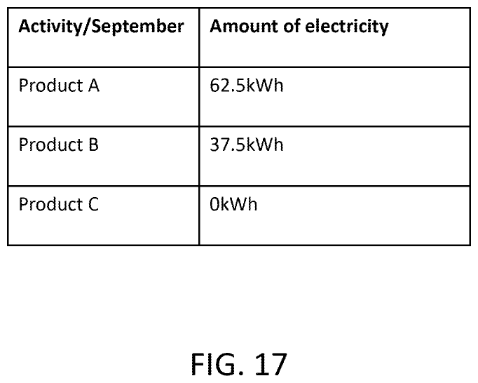

Next, as the process of step S603, first, if there is a processing request at the business to fully allocate the activity for the acquired activity information when there was no activity for any of the products (when “Product C” was not manufactured), The report generation unit 135 refers to the activity information prior to the acquired activity information (e.g., activity information with an expiration date of “August 2022”) contained in the business data 1000 stored in the business data storage unit 121, and processes the amount of electricity used in the current month proportionally based on that activity information. For example, based on the activity information with an expiration date of “August 2022” (shown in FIG. 16), the amount of electricity used by Product A and Product B, which were active (manufactured), is divided proportionally. For example, in the activity information with an expiration date of “August 2022,” it is specified that 62.5% of the electricity used is to be allocated to Product A and 37.5% to Product B. As shown in the electricity usage information in FIG. 17, 62.5% of the electricity used in September (100 kWh) (that is, 6 2.5 kWh) is allocated to Product A and 37.5% (i.e., 37.5 kWh) is allocated to Product B, as shown in FIG. 17.

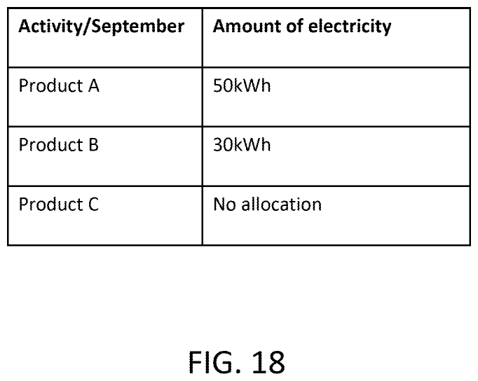

If the business requests that the amount of electricity be non-fully allocated for each product, the report generator 135 refers to the activity information acquired above (e.g., activity information with an expiration date of “September 2022”) and processes the amount of electricity used in the current month to be allocated based on that activity information. For example, based on the activity information with an expiration date of “September 2022” (shown in FIG. 12), the amount of electricity used by Product A and Product B, which were active (manufactured), is divided proportionally. For example, in the activity information with an expiration date of “September 2022,” it is specified that 50% of the amount of electricity used is allocated to Product A and 30% to Product B. As shown in the actual electricity usage information in FIG. 18, 50% (i.e., 50 kWh) of the electricity used in September (100 kWh) shall be allocated to Product A and 30% (i.e., 30 kWh) to Product B. For Product C, which had no activity, the amount of electricity shall be unallocated, and the amount of electricity equivalent to 20% that has not been allocated shall be accounted for as a separate process, such as being assigned to the company.

As described above, this embodiment can provide an efficient method to achieve management such as the calculation of greenhouse gas emissions by businesses, in particular, by specifying, for each product, the percentage of energy consumption for activities related to energy consumption, it is possible to reduce the cost of inputting the amount of electricity consumption that is input as actual values by the business. In addition, the system can provide flexible input and management, such as the ability to modify the proportion by referring to other activity information, even if the pre-specified activity information differs from the actual activity.

The above-mentioned embodiments are merely examples to facilitate understanding of the invention and are not intended to be construed as limiting the invention. It goes without saying that the invention may be changed and improved without departing from its purpose and that the invention includes its equivalents.

### DESCRIPTION OF REFERENCE NUMERALS

100 Management terminal
200 Business terminal

1. A method for managing greenhouse gas emissions, comprising:
determining information on energy consumption based on information input by a business terminal;
calculating the amount of greenhouse gas emissions based on the information on the amount of energy used;
receiving, from the business terminal, input regarding activity data concerning which product is to be allocated a predetermined percentage of the activity related to the energy usage; and
processing to assign a percentage of the energy usage to each product based on the activity data input.

2. The method of managing according to claim 1, wherein the energy usage includes electricity usage.

3. The management method according to claim 1, wherein the expiration date of the activity data is checked, and if the expiration date has expired, the input regarding the activity data is disabled.

4. The management method according to claim 1, wherein if there is no activity related to any of the products, the expiration date of the activity data is checked, and the process is performed to assign a percentage of energy usage to each product based on the expired activity data.

5. The management method according to claim 1, wherein if there is no activity for any of the products, the process is performed to assign a percentage of energy usage for each product based on the input of the activity data.
